(19) United States
(12) Patent Application Publication
(10) Pub. No.: US 2004/0248633 A1
(43) Pub. Date: Dec. 9, 2004

(54) Electromechanical sparring partner

(76) Inventors: Luther Trawick, Virginia Beach, VA (US); Moustafa R. Moustafa, Virginia Beach, VA (US)

Correspondence Address: BRADLEY D. GOLDIZEN, 505 SOUTH INDEPENDENCE BOULEVARD, SUITE 102, VIRGINIA BEACH, VA, 23452, US

(21) Appl. No.: 10/789,236

(22) Filed: Feb. 28, 2004

Related U.S. Application Data
(60) Provisional application No. 60/450,409, filed on Feb. 28, 2003.

(51) Int. Cl. G06F 17/00

(52) U.S. Cl. 463/8

(57) ABSTRACT

An electromechanical sparring partner simulates the movement and appearance of a human sparring partner. The arms and torso of the electromechanical sparring partner includes motors or actuators arranged such that the electromechanical sparring partner can throw and receive punches in an anatomically correct fashion. The torso of the sparring partner includes motors or actuators that tilt the torso from left to right and front to back. The torso connects to a base and may also twist or turn about a vertical axis. Actuators or motors raise and lower the arm as well as retract and extend the lower arm to simulate a variety of punches. The motors or actuators that move the arms and torso can be independently controlled or controlled in concert to throw a variety of punches.

This application claims priority from U.S. Provisional Patent Application Ser. No. 60/450,409 filed on Feb. 28, 2003.

The patent application did not receive federal research and development funding.

### TECHNICAL FIELD

The invention is generally directed to a training device for boxing, kickboxing, martial arts and the like, as well as recreational use in arcades. More specifically, the invention is directed towards an electromechanical training device that absorbs various blows from a user and may react thereto while throwing punches and counter punches.

### BACKGROUND OF THE INVENTION

Boxing, kickboxing and martial arts are sports that require a high amount of physical conditioning. Participants in these sports, fighters, require a means of maintaining, improving and evaluating kicking and punching skills. Previously, fighters have improved their hand-eye coordination and honed their skills by punching passive devices such as heavyweight bags, speed bags and target boards. In the past, these fighters have also kicked or punched pads held by others. Alternatively, these participants have sparred against another fighter to hone their punching and kicking skills.

Each of these previous methods fails to fully prepare a fighter for a bout. The passive devices only receive blows and offer no active resistance to the fighter. Sparring with another individual can cause damages to the participants of the sport; in fact, several heavyweight bouts have been cancelled because of injuries sustained by the participants in sparring matches.

Medical research has shown that boxing and contact martial arts can cause various medical problems. For example, injuries sustained by the participants of these sports may include concussions, brain damage, injury to various parts of the head such as the mouth, eye and ear, and even death in the most serious of these cases. It is also known that professional boxers and kick boxers can develop symptoms similar to those of Alzheimer's disease. It is believed these symptoms are a result of sustaining blows to the head region during the career of a boxer or kick boxer.

Individuals who hold pads while a participant strikes the pad may also be subject to injury. For example, the holder may sustain broken bones such as fingers or wrists resulting from the delivery of a powerful kick or blow to the pad. Thus, the pad holder, over time, may develop a tendency to unconsciously pull the pad away from the participant during training sessions. This may lead to injury to muscles of the participant, as well as, diminishing the hand-eye coordination of the fighter.

Instructors for the previously mentioned sports, require a means of demonstrating various punches, kicks, and techniques without risking injury to themselves or others. Patents have been granted on different devices eliminating the need for individuals to hold practice pads or target boards. However, these devices are passive in nature and do not actively participate against the fighter.

U.S. Pat. No. 4,889,334 to Parlow discloses a device for safely securing boards for martial arts activities. This device substantially reduces the possibility of injury to the participant's hand or foot. The device is adjustable and can hold multiple target boards to be broken.

U.S. Pat No. 4,973,045 to Heberer discloses an apparatus for positioning and securing at least one target board at a selected height and angle. This apparatus replaces the need for a human holder for the practice of breaking boards in martial arts competitions.

U.S. Pat. No. 4,403,772 to Spangel, discloses a single, contained physical conditioning structure that includes removable framework. A speedbag, as well as a heavy punching bag, is included in this apparatus.

U.S. Pat No. 5,476,433 to Bruner discloses a universal martial arts training apparatus having various target board holders and a heavy punching bag. This apparatus is directed to a device having independent training stations so that a user can move around the apparatus and train various parts of his body.

Considered individually or collectively, these prior art devices are limited as to the array of punches or kicks that can be practiced due to their restrictive nature. Moreover, these devices do not provide a real-life sparring opportunity because they only accept punches without delivering punches or counterpunching. Thus, these devices are inadequate in preparing a fighter for a competitive match. A fighter must utilize the services of a sparring partner in order to properly prepare for competitive matches or bouts.

The aforementioned US Patents are illustrative of prior art training devices. Thus, there remains a need for a universal training apparatus, which does not posses the disadvantages associated with the training devices of the prior art.

### BRIEF SUMMARY OF THE INVENTION

The present invention provides an apparatus for training boxers, martial artists, kick boxers and recreational users, collectively referred to hereinafter as “fighter(s)”. A fighter may use the invention to perfect the form and timing of punches and kicks. The apparatus includes many advantages that will be readily recognized over training with punching bags and sparring partners.

The invention includes a life-like electromechanical device that moves backwards and forward and dodges to the left and right to avoid punches with human-like movement. It can assume various fixed positions, such that the fighter can practice throwing punches and kicks in a more realistic sparring atmosphere. In order to throw a punch, a fighter may have to duck around a punch thrown by the device. The fighter enjoys many benefits from sparring with the apparatus. One major benefit is that the apparatus will assume various positions while taking multiple punches until the fighter perfects the punch thrown. For example, a fighter may throw a jab at a selected area on the device as it moves from side-to-side. Moreover, the fighter can program the apparatus to move slowly and speed up, as the fighter's skill level and ability improves in dodging punches, punching and counterpunching.

When the apparatus is in an inside fighting position, the fighter can also perfect uppercuts, left and right hooks to the body, or other such punches. Using an ordinary punching bag, the fighter cannot readily perfect these punches. In a manual mode of operation, the apparatus moves at variable speeds to accommodate each fighter's skill level. Programming allows the device to punch, dodge punches, throw counterpunches, or move up and down in accordance with selected sequence movements, or alternate fighting styles. The apparatus may be equipped with sensors that cause it to react to various moves or punches thrown by the fighter. Moreover, the apparatus may be equipped with sensors such that it can move in any direction to follow an opponent during sparring sessions. That is to say, the device may twist, turn or reposition itself to the left or right to face a fighter that has moved. This repositioning can be achieved either through a programmed manual mode or by a remote controller. A fighter may kick or punch any part of the device during movement of the device. He may also punch or kick the device when it is in a stationary sparring position.

The apparatus is shaped like a human to include a head, torso, legs and arms. It also comprises a base and control circuitry. Actuators within the device cause the device to move with human-like movements. For example, an actuator(s) within the neck of the device may cause the head to move side-to-side and front-to-back. The head may also rotate in a circular fashion about an axis of rotation. The torso region of the apparatus above the waist moves side-to-side, front-to-back, and in a circular or radial motion about a vertical axis of rotation in a similar fashion to the head. The legs of the device assume a stationary boxing position, one foot ahead of the other position to portray a structure of strength and stability. The legs may be positioned for a left-handed or right-handed fighter.

The arms of the device include various motions that mimic those of an actual fighter. For example, the device can throw an array of punches towards the fighter. Some of these punches include: a right or left hand straight punch, a singe or double jab, a right or left upper cut, a right or left cross, a right or left hook, and a combination of punches. The device typically throws these punches towards the head, torso or arm regions of the fighter. Alternatively, the device may assume a defensive posture or throw a counter punching sequence towards the fighter.

The device includes programmed variable speed arm movements that may have a sequential and reversible rhythm. The movements incorporate variations of the pitch and roll motions within the arms. Since the device includes an anatomically correct body that is configured or matched closely to actual life-size geometry of a sparring partner, the aesthetic and functional components of the device may include metallic, plastic and/or electrometric materials that provide structural integrity to the device. Exterior body components may comprise polymer and elastomeric derivatives that are pre-qualified for structural compliance and chemical resistance to many known household chemicals.

The device may also incorporate digital and/or analog counting sensors to record punching contact occurrence for competitive contests. Impact recording sensors may be places at strategic locations on the device, such as the face, chest, arms and ribcage regions for awarding points. Data output from these sensors may be fed into an adder circuit that counts the points scored for display on a screen. The points scored may include the total number of delivered punches observed by the sensors in each region. Various point values are assigned for different regions of the device. Different point values may be assigned for varying magnitudes of force associated with punches that are observed by the sensors. For example, the punching point system could be based on impact force, as well as body parts punched. One such system that comprises a kick-boxing scoring system is U.S. Pat. No. 6,110,079 to Luedke et al. that is incorporated by reference thereto.

The apparatus is designed for operation with alternating or direct current. It may include recharging circuitry along with a rechargeable battery. In this fashion, the battery may be charged before use and the apparatus may be moved to a desired location for use.

The apparatus includes a base that may comprise hollow legs through which control circuitry is routed, roller wheels and lockdown mechanisms such that the fighter can move the device into position readily and thereafter secure it for operation. Brakes may lock each of the roller wheels during use.

The apparatus may include programmable drive systems, such as linear actuators and direct-drive modules for moving the various components and parts of the device.

During manual variable speed operation, the apparatus may continuously left and right punch at variable speeds. Alternatively, it may punch at continuous speeds with either and/or the left or right arm. It may dodge a fighter's blows using variable speeds by turning the torso to the left or right and moving it up and down at various speeds, as well as the head.

The apparatus may include a programmed punch sequence, for example, three left jabs and a straight right or two left jabs and a straight right and/or left hook, or any such similar combination of punches. Body sensors within the apparatus can record a fighters punching and kicking power, as well as the number of punches or kicks thrown to the apparatus. In the preferred embodiment, the apparatus includes a controller, CPU and a power supply, as well as a base upon which the apparatus is mounted.

It is an object of the present invention to provide a martial arts training device that simulates a real-life sparring partner. The device is anatomically correct in size and exhibits movements similar to those of a human sparring partner.

It is further an object of the invention to provide an electromechanical sparring partner that can assume various positions for practicing the same punch or kick repeatedly. The sparring partner includes actuators that may be operated singularly or in concert to avoid or throw punches.

The above and further objects, details and advantages of the invention will become apparent from the following detailed description, when read in conjunction with the accompanying drawings.

### BRIEF DESCRIPTION OF THE DRAWINGS

FIG. 1A is a perspective view of the instant invention.

FIG. 1B is a perspective view of the invention shown in the ready position. The arms are bent and held in front of the electromechanical sparring partner.

FIG. 1C is a perspective view of the invention shown throwing a right straight punch. The right arm is extended while the torso is leaning slightly forward in this position. The left arm is bent and held in front of the electromechanical sparring partner.

FIG. 1D is a perspective view of the invention shown throwing a right uppercut punch. The torso is leaning slightly forward and twisted towards the left. The right arm is bent while the left hand is held in a ready position.

FIG. 1E is a perspective view of the invention shown throwing a right hook punch. The torso is leaning forward while the right shoulder is raised. The right arm is bent and ready to deliver a punch. The left arm is held in a ready position.

FIG. 2 is an electrical schematic view of the present invention. Nine motors or actuators are included for activating the torso and arms. Wires connect control circuitry with the motors or actuators.

FIG. 3A is a perspective view of the torso movement assembly and showing the motors or actuators that move the torso.

FIG. 3B is an overhead view of the torso assembly taken from the front and showing it tilted towards a right direction.

FIG. 3C is an overhead view of the torso assembly showing it tilted towards the front and left.

FIG. 3D is an overhead view of the torso assembly showing it in a relatively upright position.

FIG. 3E is a perspective view of the torso assembly shown from the bottom.

FIG. 4A is a perspective view of the arm actuation assembly shown from above.

FIG. 4B is a perspective view of an arm actuation assembly shown if the ready position.

FIG. 4C is a perspective view of the arm actuation assembly shown in the straight position.

FIG. 4D is a perspective view of the arm actuation assembly shown in an uppercut position.

FIG. 4E is a perspective view of the arm actuation assembly shown in a cocked position for throwing a hook.

FIG. 4F is a perspective view of the arm actuation assembly shown in FIG. 4E after the hook punch has been thrown.

### DETAILED DESCRIPTION OF THE INVENTION

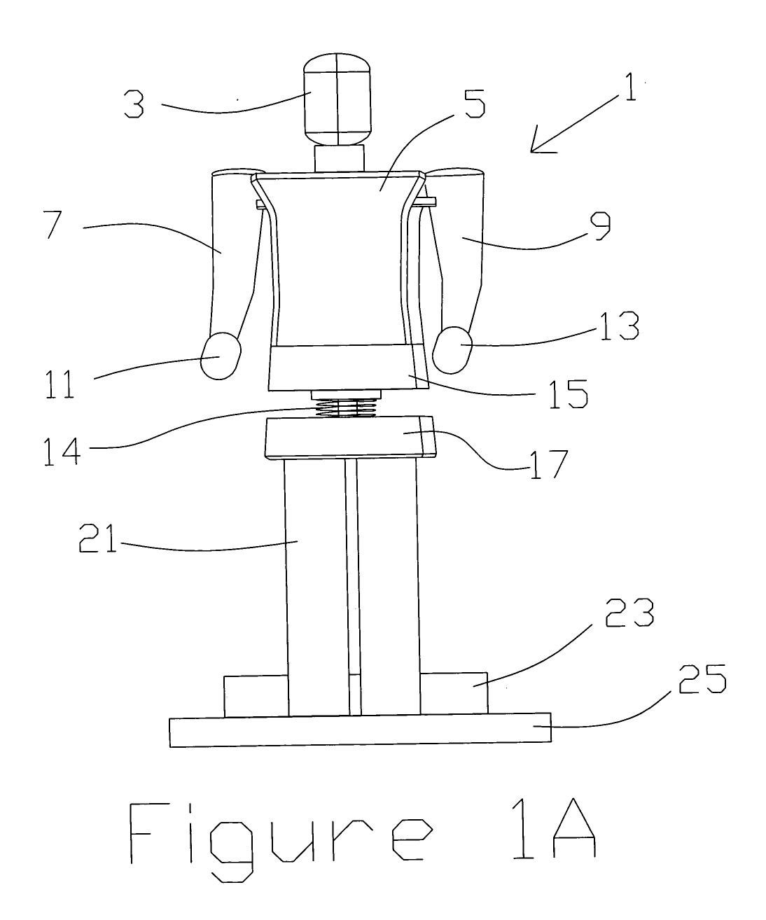

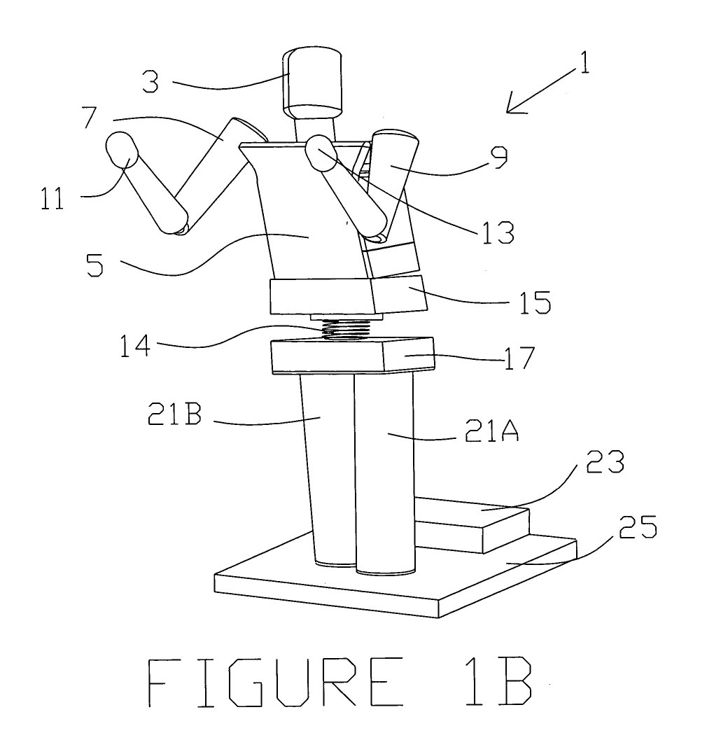

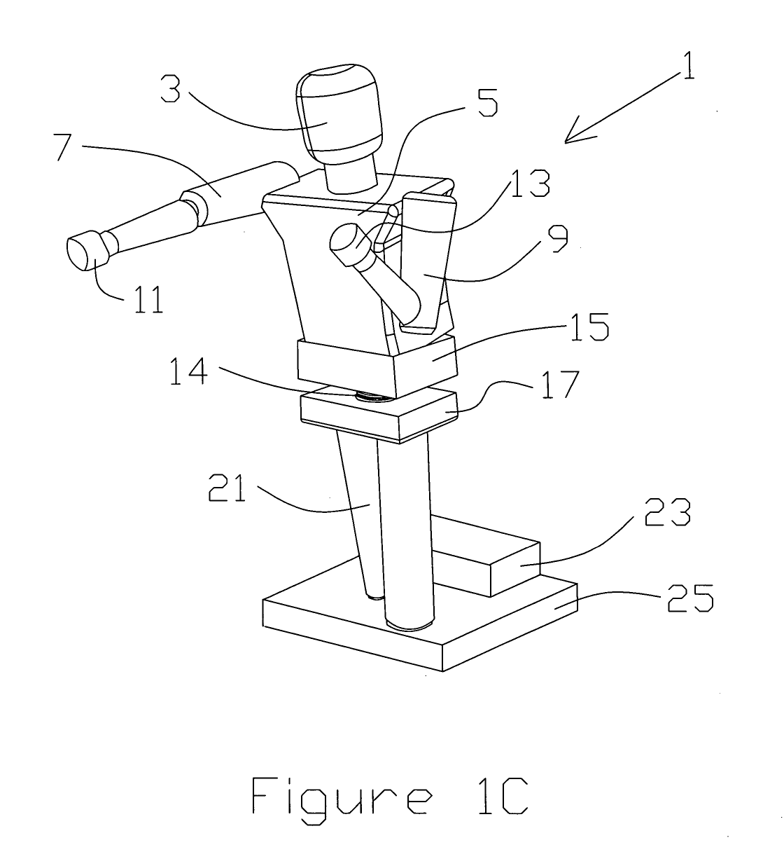

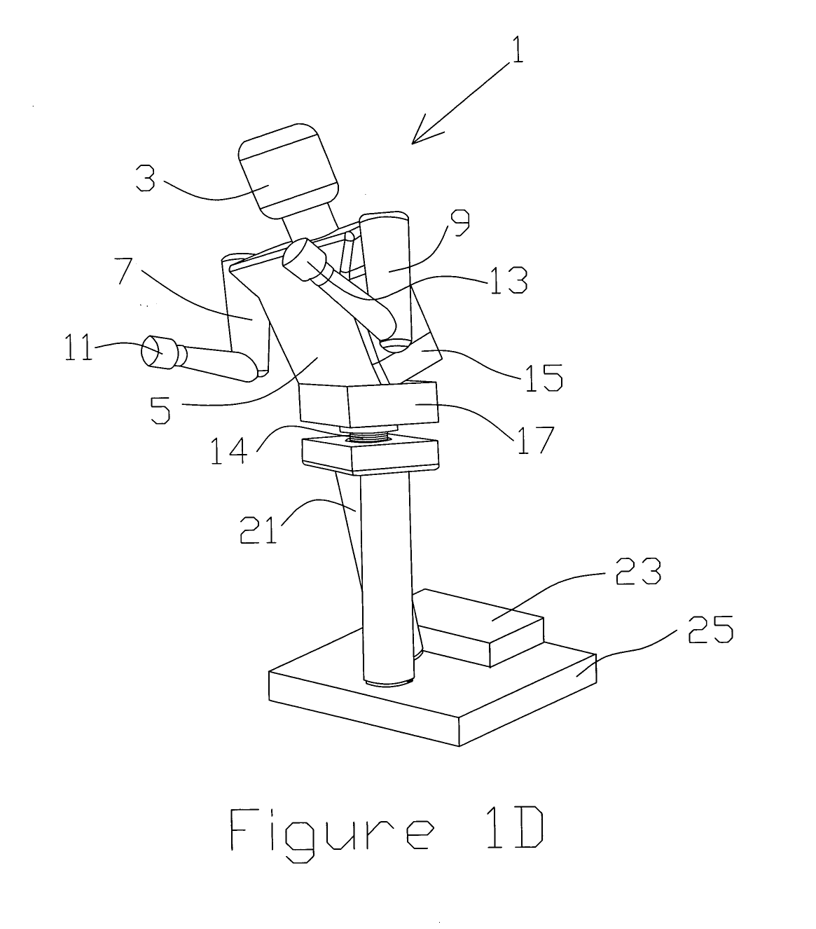

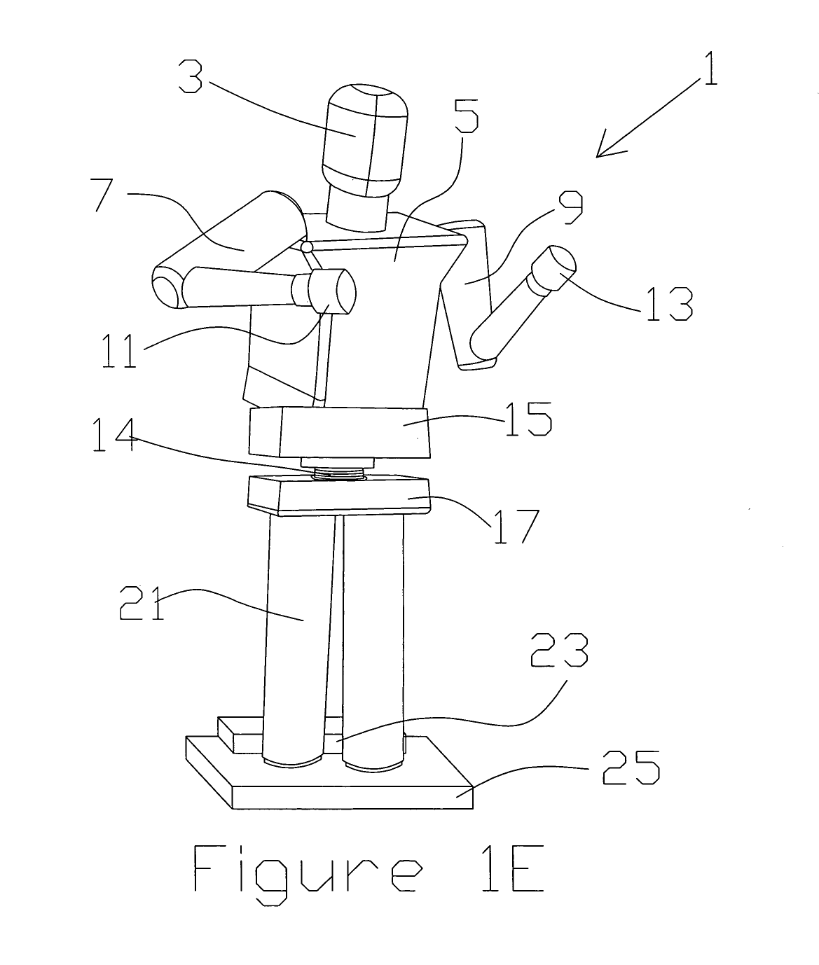

FIG. 1A is a perspective view of the electromechanical sparring partner 1. The sparring partner 1 is anatomically correct and includes a head 3, a torso 5, a right arm 7, and a left arm 9. The sparring partner 1 may include a spring positioned between the head 3 and the torso 5. Boxing gloves 11 and 13 are affixed at ends of right and left arms 7 and 9, respectively. The head 3 and torso 5 may be comprised of lightweight, durable material such as plastic, titanium, aluminum, steel and other such materials.

Torso 5 includes an upper waist region 15 and a lower waist region 17 coupled together via a spring 14. A skirt, not shown, may surround the spring to prevent injury to a fighter. A torso movement assembly 69, discussed hereinafter may be incorporated in either the upper waist region 15 or the lower waist region 17 for moving the torso into a plurality of positions. Legs 21 connect at one end to lower waist region 17 and at an opposite end to a base 25. Base 25 may include a weighted portion for stabilizing the sparring partner. A control box 23 for housing control circuitry and a power supply 31 rests atop base 25.

FIGS. 1B through 1E depict the electromechanical sparring partner 1 in various positions. In FIG. 1B, the sparring partner 1 is in a ready position. The position of the left leg 21A is forward relative to the right leg 21B. The legs 21 may be adjustably fixed in tracks, not shown, such that the sparring partner 1 can assume either a left-handed or right-handed fighting position.

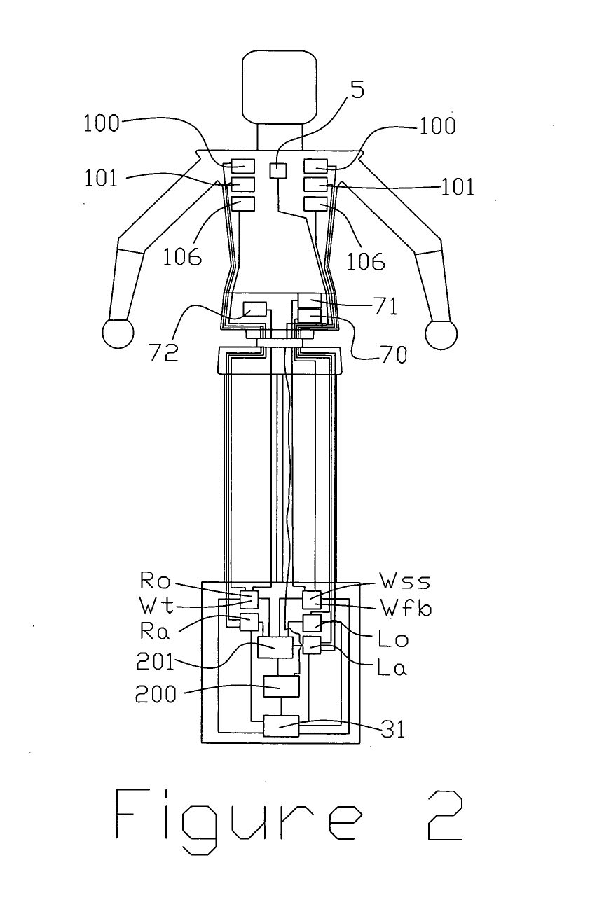

FIG. 2 is a schematic view of the control circuitry and various actuators that control and move the sparring partner 1. In the schematic, Ro denotes the control circuitry for the motor or actuator that controls the push-out motion of the shoulder of the right arm; whereas Lo denotes the control circuitry for controlling the motor or actuator that controls the push-out motion of the left arm. Ra denotes the control circuitry that controls the raising and lower of the right arm. This control circuitry may also control the extension and retraction of the lower right arm as discussed hereinafter. La denotes the control circuitry that controls the raising and lower of the left arm. This control circuitry may also control the extension and retraction of the lower left arm as discussed hereinafter. S denotes a sensor or an array of sensors that detect a position of the fighter and react thereto. The sensors may also include pressure sensors for scoring hits as mentioned above.

Movement of the torso 5 is controlled by control circuitry denoted as Wt which controls the twisting of the torso as discussed hereinafter. Control circuitry denoted as Wss controls the side-to-side tilting motion of the torso 5. Control circuitry Wfb denotes the control circuitry for controlling the actuator or motor that moves the torso 5 in a forward-backward tilting motion.

A programmable microprocessor or controller 200 controls the actuation of the motors or actuators such that each motor can operate independently of the others or act in concert with any of the others to throw an infinite amount of varying punches including those shown in FIGS. 1B through 1E. The power supply 31 is coupled to the control circuitry via an interface 201. Power supply 31 provides power to the controller 200 for driving the various motors or actuators that move the sparring partner.

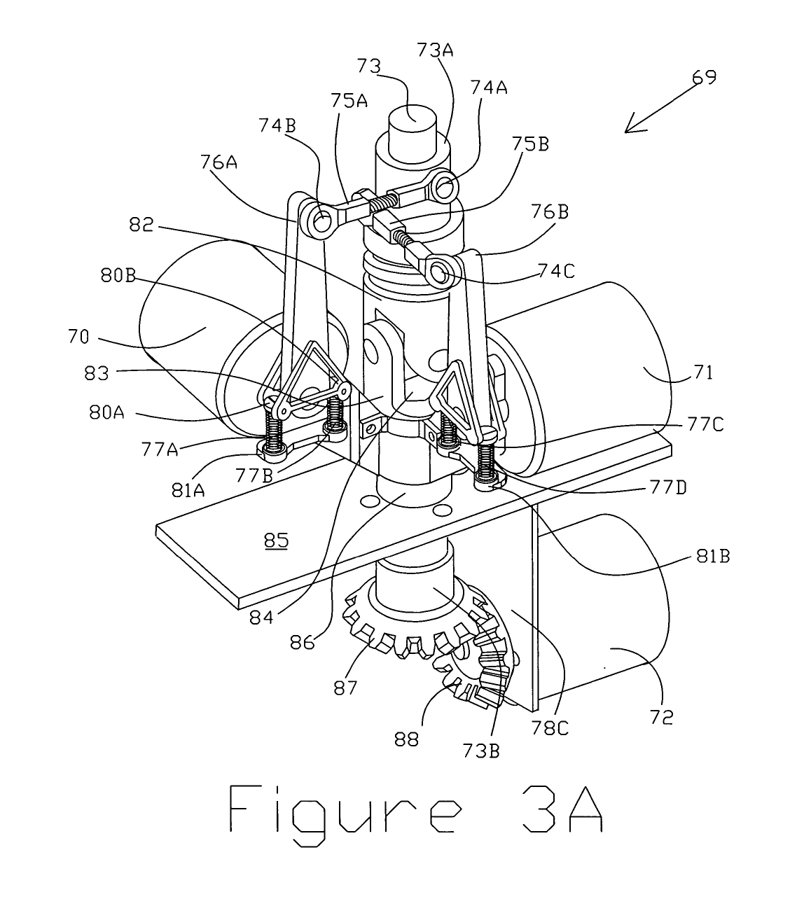

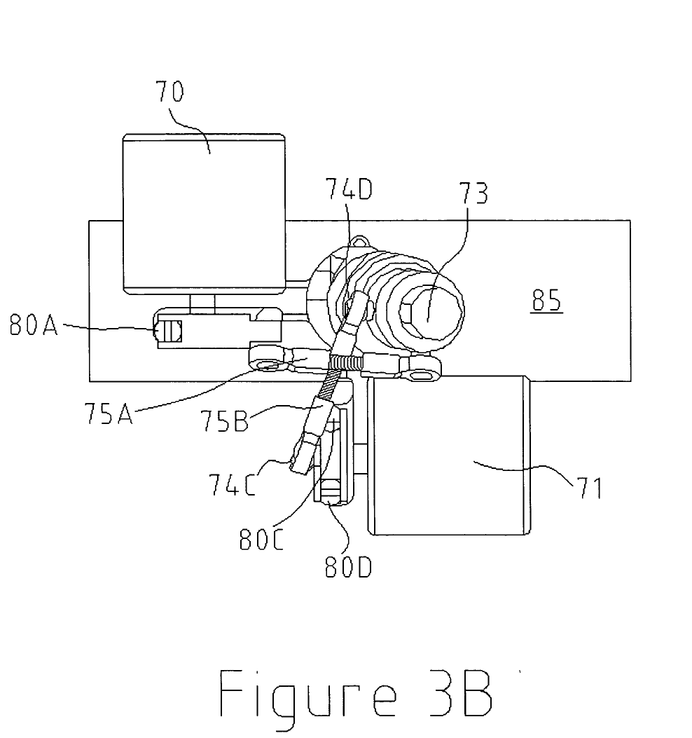

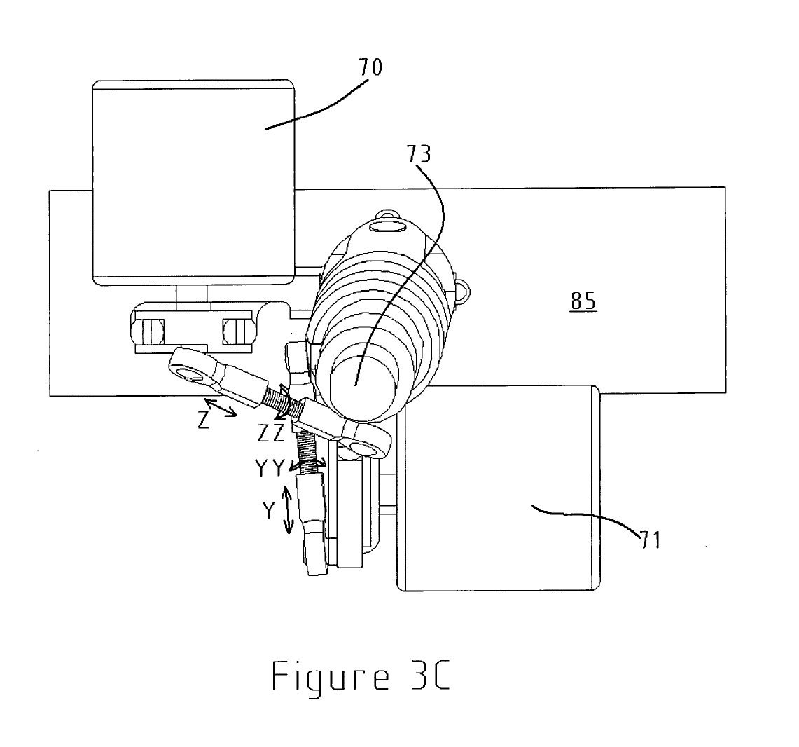

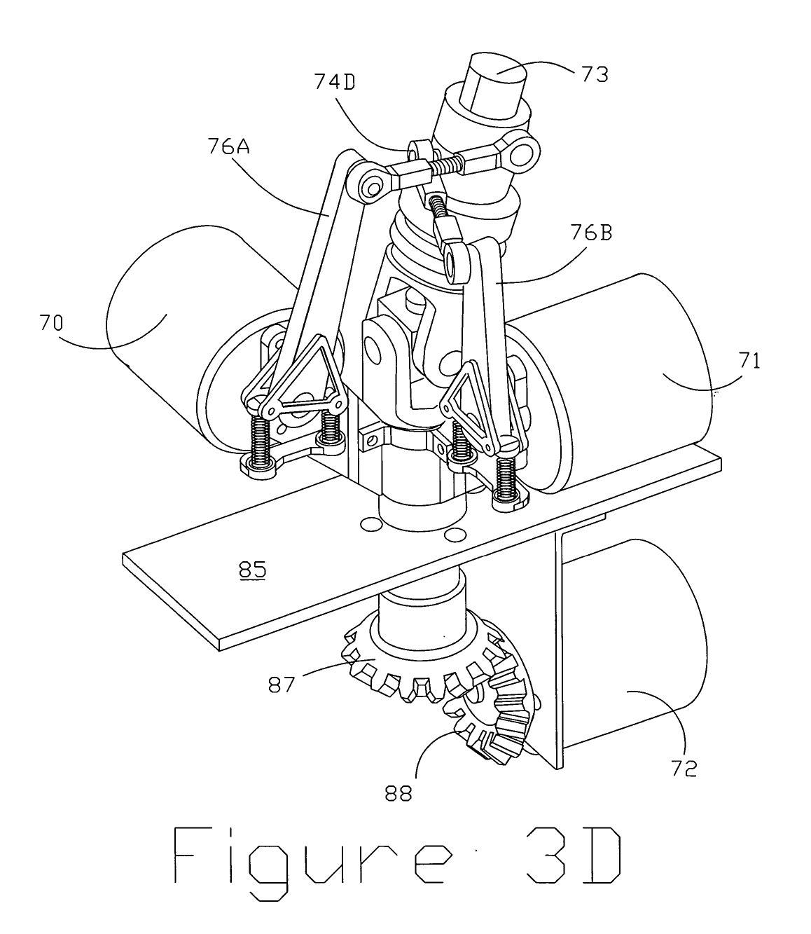

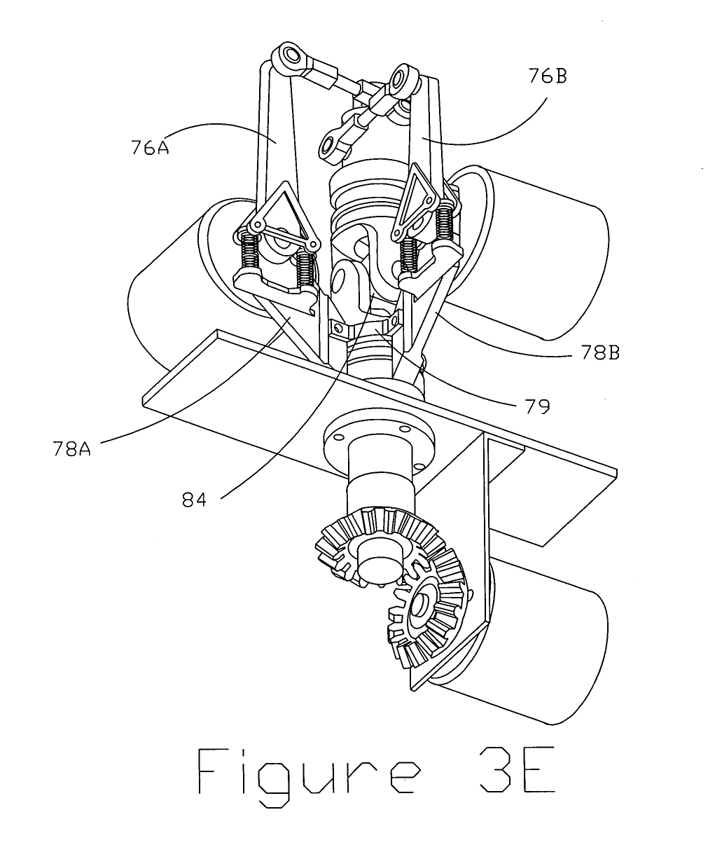

FIGS. 3A through 3E depict the torso movement assembly 69. A torso shaft 73 includes an upper portion 73A and a lower 73B. The upper portion 73A includes an upper yoke 82 fixed at a bottom end. The lower portion 73B includes a lower yoke 83 fixed at an upper end. The upper end of the upper portion 73A is affixed to torso 5. The yokes 82 and 83 are coupled together via a universal joint 84 similar to a transmission unit of an automobile. The lower portion 73B passes through an opening in torso assembly plate 85 that may be equipped with press-in bearings 86.

The torso movement assembly 69 includes a side-to-side tilt motion motor 70 for causing the torso 5 to be tilted in a side-to-side manner. The motor 70 is mounted to a motor mount 78A that in turn is affixed to a motor mount collar 79. A motor shaft of motor 70 is coupled to a rocker arm linkage 76A for translating rotation motion from the motor shaft to the torso shaft 73.

The torso movement assembly 69 also includes a front-to-back tilt motion motor 71 for causing the torso 5 to be tilted in a front-to-back manner. The motor 71 is mounted to a motor mount 78B that in turn is affixed to a motor mount collar 79. The motor mount collar is mounted to the lower portion 73B. A motor shaft of motor 71 is coupled to a rocker arm linkage 76B for translating rotation motion from the motor shaft to the torso shaft 73.

The motor shaft from each motor 70 and 71 is coupled to a rocker arm linkage 76A and 76B, respectively. Each rocker arm linkage includes a pair of spring caps 80A-80D for holding upper ends of springs 77A-77D in place. Typically, the spring caps 80A-80D include pins that pass through orifices in the rocker arm linkages to hold the caps 80A-80D in place. Spring plates 81A and 81B include recesses for maintaining springs 77A-77D in place during operation. The springs 77A-77D help buffer or absorb energy from a fighter's blows to prevent the motors from being damaged or becoming jammed during operation.

Tie rod linkages 75A and 75B connect at one end to the rocker arm linkages 76A and 76B as shown. An opposite end of tie rod linkages 75A and 75B connects to the torso shaft in a known manner. Each tie rod linkage 75A and 75B is adjustable and includes a ball joint 74A through 74D at each end. Typically, the tie rod linkages 75A and 75B include a threaded portion as shown for providing an adjustment means for adjusting the distance between the rocker arm linkages 76A and 76B and the torso shaft 73. The tie rod linkage is substantially similar to tie rods used on automobile steering systems. The ball joints 74A through 74D allow the tie rod linkages 75A and 75B a freedom of movement to prevent either from being damaged by the movement of the other as better seen in FIGS. 3B and 3C. That is to say, when the side-to-side tilt motion motor 70 is operated simultaneously with the front-to-back tilt motion motor 71, the linkages may become damaged or jammed without the ball joints.

Rotational motion twist motor 72 is mounted to torso assembly plate 85 via motor mount 78C. A drive gear 88 is attached to a motor shaft of motor 72 as can easily seen in FIGS. 3A, 3D and 3E. The drive gear transfers rotational energy or motion from the motor 72 to the torso shaft 73 via a driven gear 87 attached at a lower end of lower portion 73B. The gears 87 and 88 shown in these figures are beveled gears. However, it can be readily recognized by a skilled artisan that various other types of gears may be suitable for the purposes of carrying out the invention.

FIG. 3C depicts movement of the tie rod linkage 75A and 75B. As can be seen, the linkages 75 translate motion from the motors 70 and 71 in directions of arrows Z and Y. Arrows ZZ and YY represent the twist angle that the tie rod linkages may assume. Thus, the torso shaft 73 may be tilted about an axis that passes through the upper and lower portions 73A and 73B. With the torso movement assembly 69 of the present invention, the torso 5 may be tilted in an infinite amount of directions.

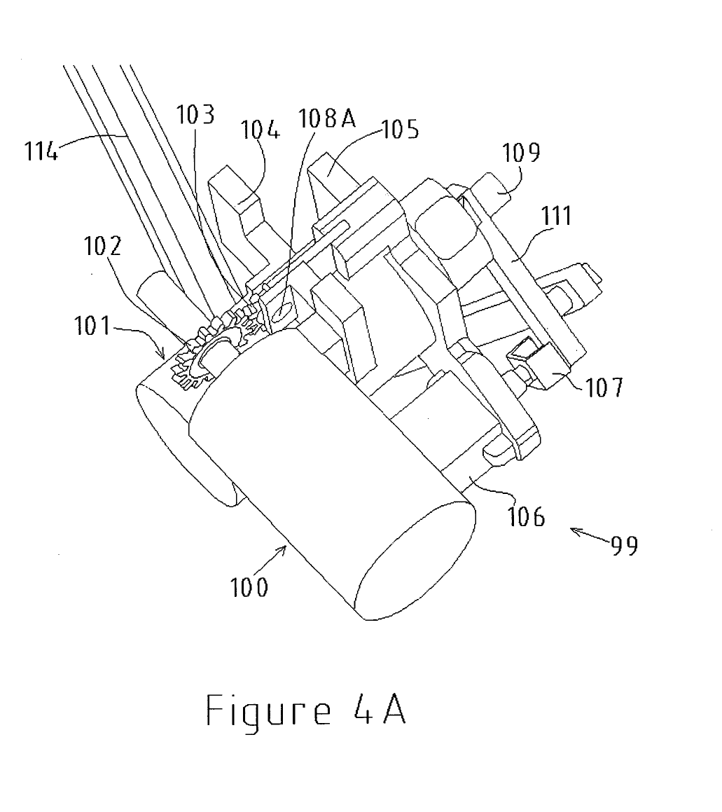

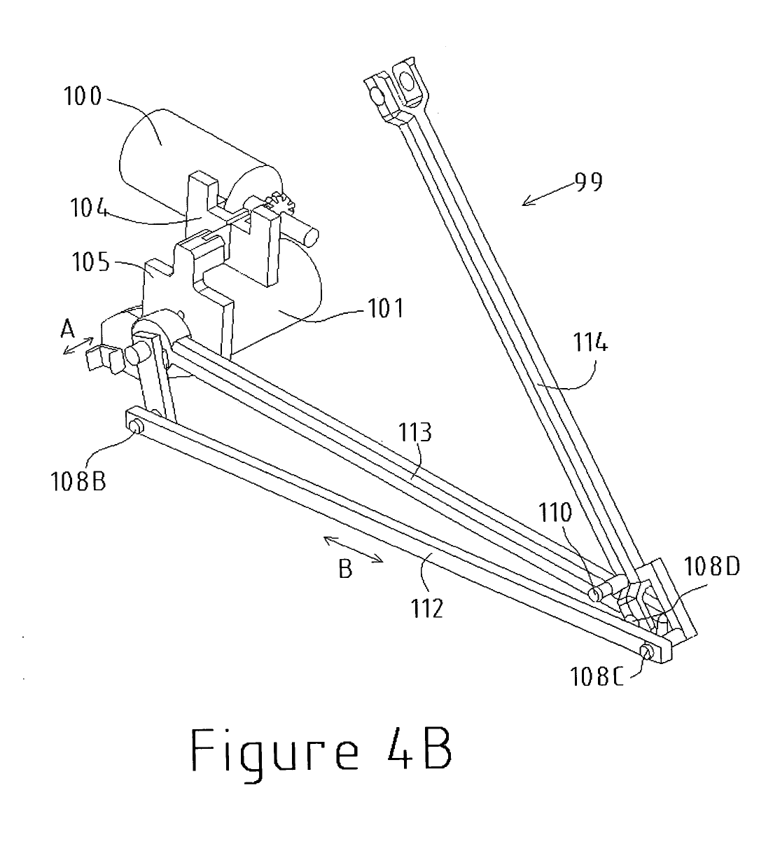

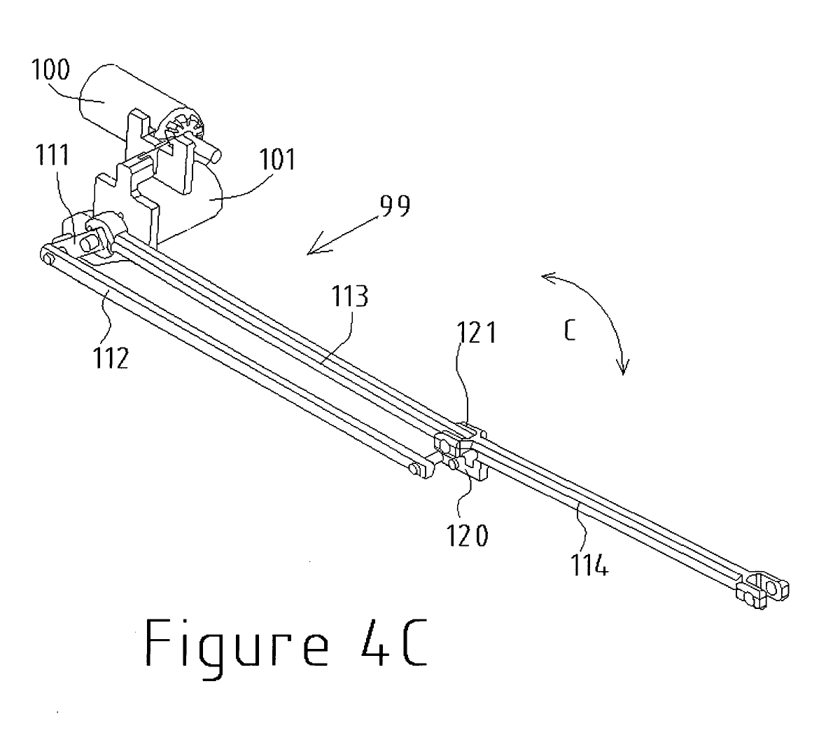

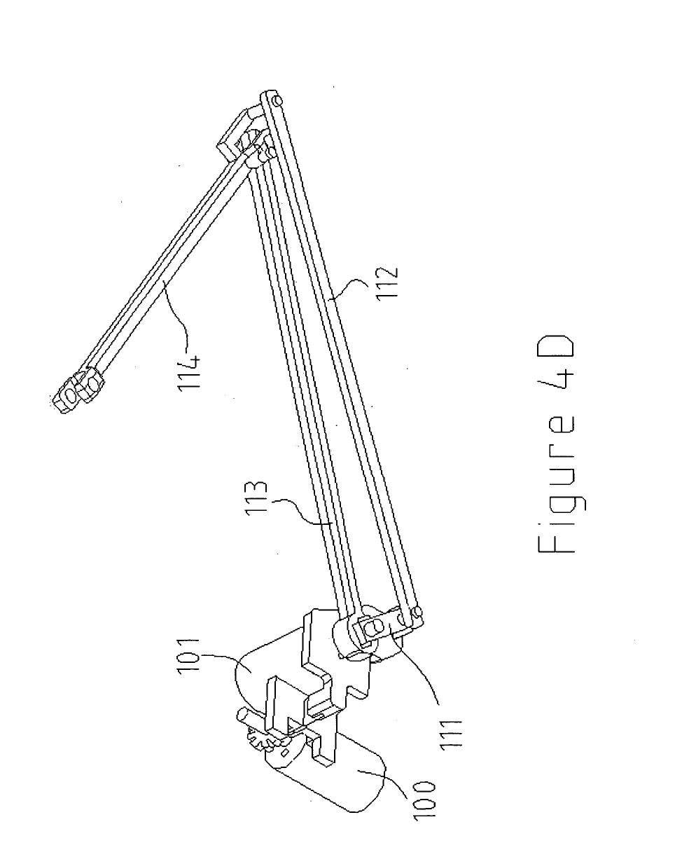

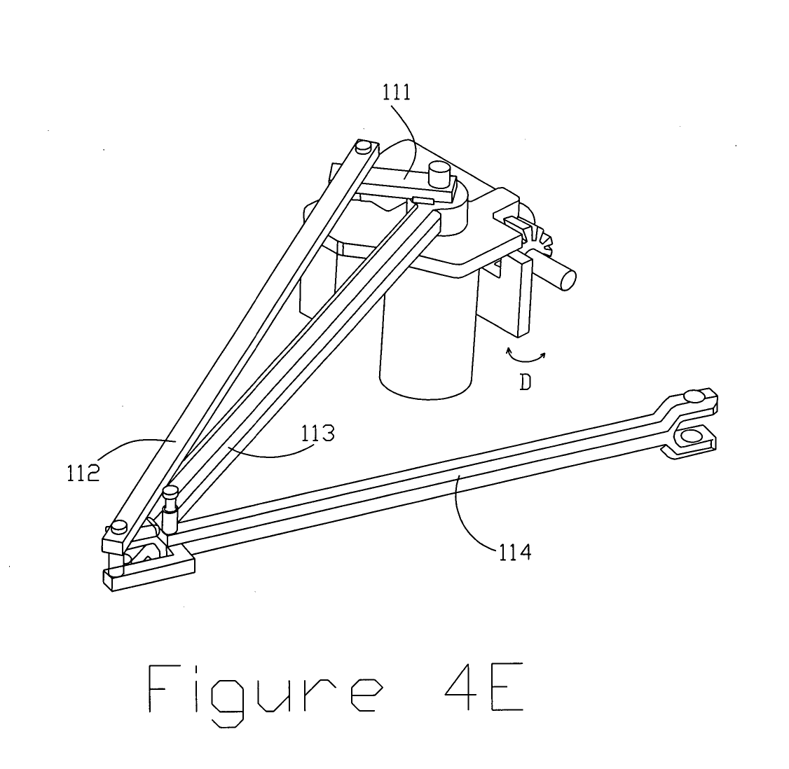

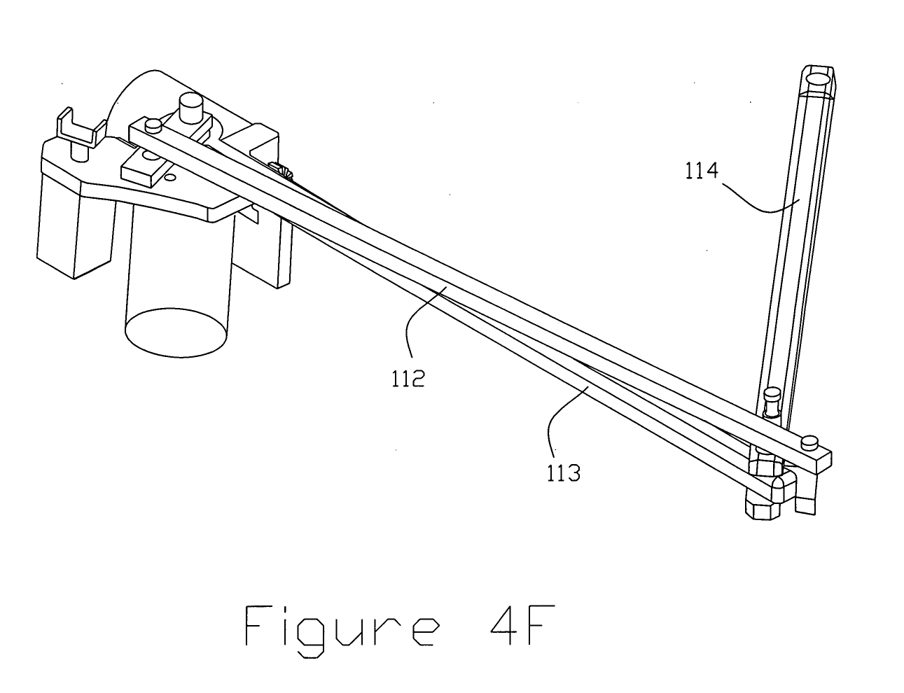

FIGS. 4A through 4E show the arm actuation assembly 99. The assembly 99 comprises two motors 100 and 101 for raising and lowering the shoulder as well as extending and retracting the lower arm. The arms 7 and 9 comprise an upper arm frame 113 and a lower arm frame 114. An end of upper arm linkage 113 connects to a motor shaft 109 of extend and retract arm motor 101. An opposite end of upper arm frame 113 connects yoke 121 of lower arm frame 114 via pin 108D. A stop 110 limits the range in which the lower arm frame 114 may be retracted.

A catch linkage 111 is also mounted at one end on the motor shaft 109 of extend and retract arm motor 101. An opposite end of the catch linkage 111 connects with an extend and retract linkage 112 via pin 108B. An opposite end of extend and retract linkage 112 connects to extension 120 via pin 108C.

A raise and lower arm motor 100 includes a shaft having a raise and lower arm drive gear 102 mounted thereon. The raise and lower arm drive gear 102 communicates with teeth 103 on a rotating motor mount plate 105. The rotating motor mount plate connects to fixed motor mount plate 104 via pivot pin 108A. A solenoid 106 is mounted to the rotating motor mount plate 105. A yoke 107 is fixed to an end of the solenoid 106 for selectively engaging catch linkage 111.

Now turning to the operation of the arm actuation assembly 99, Arrow A in FIG. 4B shows the movement of yoke 107. Arrow B in this same figure illustrates the direction of movement of the extend and retract linkage 112. Arrow C in FIG. 4C depicts the direction of movement of lower arm frame 114. Arrow D of FIG. 4E illustrates the direction of rotation of the rotating motor mount plate 105.

Solenoid 106 controls the operation of the extend and retract linkage 112. By selectively engaging yoke 107 to immobilize catch linkage 1 11, the movement of extend and retract linkage 112 may be varied. In FIG. 4B, the lower arm frame member 114 assumes an angle of less than 180 degrees with respect to the upper arm 113 to cause the lower arm of the sparring partner to bend. In FIG. 4C, yoke 107 engages catch linkage 111 to prevent it from pivoting to cause lower arm frame 114 to decrease an angle between frame 114 and frame 113. In this case, the arm is positioned for throwing a straight punch. FIG. 4D shows the yoke 107 engaged with catch linkage 111 to cause the arm to assume an upper cut position.

In FIGS. 4E and 4F, the moveable or rotating motor mount plate 105 is rotated away from fixed motor mount plate 104 to cause the arm to be raised. As can be easily recognized by a skilled artisan, the yoke 107 may selectively engage the catch linkage 111 as shown in this view to retract lower arm frame 114 as shown. In this instance, the arm is cocked for throwing a hook punch. In FIG. 4F, the yoke 107 is disengaged from catch linkage 111, in an extended position for a hook.

We claim:

1. An electromechanical sparring partner comprising:
a base including legs that provide support such that a the electromechanical sparring partner can throw and receive punches;
a torso connected to said base and including a torso movement assembly for turning and tilting said torso about an axis;
a right arm including an upper and lower arm portion and connected to said torso, said right arm further including a right arm actuation assembly for raising, lowering, extending and retracting said right arm;
a left arm including an upper and lower arm portion and connected to said torso, said left arm further including a left arm actuation assembly for raising, lowering, extending and retracting said left arm;
a controller connected to the torso movement assembly, the right arm actuation assembly, and the left arm actuation assembly and for controlling an operation of each assembly; and,
a power supply for providing power to said controller.

2. The electromechanical sparring partner of claim 1 wherein at least one of said right and left arm actuation assembly includes:
a first motor mount plate;
a first motor including a first motor shaft and for raising and lowering an arm mounted to said fixed motor mount plate;
a gear having teeth and coupled to said shaft;
a second motor mount plate including teeth in communication with the gear and pivotally connected to said first motor mount;
a second motor including a second motor shaft mounted on said rotating motor mount plate;
an upper arm frame member affixed to said second motor shaft;
a catch linkage affixed at an end to said second motor shaft;
an extend and retract linkage having a first end and a second end, said extend and retract linkage pivotally connected to at the first end to said catch linkage;
a lower arm frame member pivotally connected to said upper arm frame member and the second end of said extend and retract linkage.

3. The electromechanical sparring partner of claim 1 wherein said torso movement assembly comprises:
a torso shaft connected to a torso at one end;
a first motor coupled to said torso shaft for tilting said torso shaft in a first direction;
a second motor coupled to said torso shaft for tilting said torso shaft in a second direction wherein said second direction is perpendicular to said first direction; and,
a third motor coupled to an end of said torso shaft opposite said torso, said third motor for twisting the torso shaft about a axis.

4. The electromechanical sparring partner of claim 3 wherein said torso movement assembly further comprises:
a first rocker linkage including a first and second end, said first end connected said first motor;
a first tie rod linkage having two ends, one end connected to said first rocker linkage opposite the first motor and an opposite end connected to said torso shaft;
a second rocker linkage including a first and second end, said first end connected to said second motor; and,
a second tie rod linkage having two ends, one end connected to said first rocker linkage opposite the second motor and an opposite end connected to said torso shaft.

5. The electromechanical sparring partner of claim 4 wherein said first and second tie rod linkages include ball joints at either end.

6. An anatomically correct electromechanical sparring partner including at least structural components of a head, a torso, at least one arm and a base, said sparring partner comprising:
means for raising an arm connected to said torso;
means for straightening and bending the arm connected to said torso;
means for tilting said torso; and,
means for twisting said torso.

7. The anatomically correct electromechanical sparring partner of claim 6 comprising a covering consisting of one or more selected from a group of polymer and elastomeric derivatives.

8. The anatomically correct electromechanical sparring partner of claim 6 wherein said means for raising the arm includes an electric motor arranged in said torso such that the electric motor is energized to raise the arm.

9. The anatomically correct electromechanical sparring partner of claim 6 wherein said structural components comprise materials consisting of one or more selected from a group of metallic, plastic and elastomeric materials.

10. The anatomically correct electromechanical sparring partner of claim 6 wherein said means for tilting the torso tilts the torso in a side-to-side direction.

11. The anatomically correct electromechanical sparring partner of claim 6 wherein said means for tilting the torso tilts the torso in a front-to-back direction.

12. The anatomically correct electromechanical sparring partner of claim 6 wherein said means for tilting the torso includes one or more selected from a group consisting of linear actuators, direct drive modules and motors.

13. The anatomically correct electromechanical sparring partner of claim 6 wherein said means for twisting the torso includes one or more selected from a group consisting of linear actuators, direct drive modules and motors.

14. A electromechanical sparring partner for throwing an array of punches towards a fighter comprising:
a torso that twists about an axis and tilts with respect to said axis;
arms connected to said torso, said arms raise, extend and retract such a variety of punches may be thrown by the robotic sparring partner; and,
a base connected to said torso for providing a stable platform.

15. The electromechanical sparring partner of claim 14 wherein said torso includes one or more selected from a group consisting of linear actuators, direct drive modules and motors.

16. The electromechanical sparring partner of claim 14 further comprising two motors and a solenoid for raising, extending and retracting said arms.

17. The electromechanical sparring partner of claim 14 further comprising three motors connected to and position within the torso for tilting and twisting said torso.

18. The electromechanical sparring partner of claim 14 further comprising at least one sensor for detecting a position of a fighter and responding thereto.

19. The robotic electromechanical partner of claim 14 further comprising an array of sensors for detecting when a punch strikes said robotic sparring partner.
